(19) United States
(12) Patent Application Publication
(10) Pub. No.: US 2003/0154999 A1
(43) Pub. Date: Aug. 21, 2003

(54) Method for preventing chemical attack on a copper containing semiconductor wafer

(75) Inventors: Tsu Shih, Hsin-Chu (TW); Ying-Tsung Chen, Chiai (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/082,009

(22) Filed: Feb. 20, 2002

(51) Int. Cl. B08B 3/10

(52) U.S. Cl. 134/1.3; 134/3

(57) ABSTRACT

A method for preventing a photo-induced chemical attack on a copper containing dielectric material including providing a copper or copper oxide containing dielectric material having an exposed copper containing surface; providing an acidic cleaning solution for contacting the exposed copper containing surface; and, shielding the exposed copper containing surface to substantially block incident light from impacting the exposed copper containing surface while contacting the exposed copper containing surface with the cleaning solution.

### FIELD OF THE INVENTION

This invention generally relates to chemical mechanical CMP methods and post-CMP cleaning methods and more particularly to methods for preventing chemical attack of a copper containing semiconductor substrate.

### BACKGROUND OF THE INVENTION

In semiconductor fabrication, various layers of insulating material, semiconducting material and conducting material are formed to produce a multilayer semiconductor device. The layers are patterned to create features that taken together, form elements such as transistors, capacitors, and resistors. These elements are then interconnected to achieve a desired electrical function, thereby producing an integrated circuit (IC) device. The formation and patterning of the various device layers are achieved using conventional fabrication techniques, such as oxidation, implantation, deposition, epitaxial growth of silicon, lithography, etching, and planarization.

Planarization, for example, is an increasingly important in semiconductor manufacturing technology. As device sizes decrease, the importance of achieving high resolution features through photolithographic processes correspondingly increases thereby placing more severe restraints on the degree of planarity of a semiconductor wafer processing surface. Excessive degrees of process surface non-planarity will affect the quality of several semiconductor process including, for example, in a photolithographic process, the positioning the image plane of the process surface within an increasingly limited depth of focus window to achieve high resolution semiconductor feature patterns.

One planarization process is chemical mechanical polishing (CMP). CMP is increasingly being used for planarizing dielectrics and other layers, including applications with increasingly stringent critical dimension semiconductor fabrication processes. CMP planarization is typically used several different times in the manufacture of a multi-layer semiconductor device. For example, CMP is used as one of the processes in preparing a layered device structure in a multi-layer device for subsequent processing. For example, CMP may be used at a stage for removing excess metal after filling conductive metal interconnects such as vias and trench lines which act to electrically interconnect the several layers and areas that make up a multi-layer semiconductor device.

In a typical process for forming conductive interconnections in a multi-layer semiconductor device, for example, a damascene process is used to form vias and trench lines for interconnecting different layers and areas of the multilayer device. Vias (e.g., V1, V2 etc. lines) are generally used for vertically electrically interconnecting semiconductor device layers and trench lines (e.g., M1, M2, etc. lines) are used for electrically interconnecting semiconductor device areas within a layer. Vias and trench lines are typically formed as part of a damascene process. Although there are several different methods for forming damascene structures, one typical method generally involves patterning and etching a semiconductor feature, for example a via opening within an insulating dielectric layer to make contact with a conductive area within an underlying layer of the multilayer device. The via opening (plug) may then be filled with for example, copper to form a via (plug) followed by a CMP step to remove excess metal deposited on the insulating dielectric layer surface and to planarized the surface for a subsequent processing step. A second insulating dielectric layer is then deposited followed by patterning and etching the second insulating dielectric layer to form a trench opening situated over the via. The trench opening is then filled with a metal, for example, copper, to form trench lines (intralayer horizontal metal interconnections). A second CMP step is then carried out similar to the first CMP step to remove excess metal and to planarize the process wafer surface in preparation for further processing.

CMP is widely accepted as the preferred process for many planarization processes including planarizing copper filled trench lines. CMP is the method of choice particularly for smaller device fabrication technologies including dimensions of less than 0.25 micron. CMP generally includes placing a process surface of the wafer in contact against a flat polishing surface, and moving the wafer and the polishing surface relative to one another. The polishing action is typically aided by a slurry which includes for example, small abrasive particles such as colloidal silica (SiO₂) or alumina (Al₂O₃) that abrasively act to remove a portion of the process surface. Additionally, the slurry may additionally include chemicals that react with the process surface to assist in removing a portion of the surface material, the slurry typically being separately introduced between the wafer surface and the polishing pad. During the polishing or planarization process, the wafer is typically pressed against a rotating polishing pad. In addition, the wafer may also rotate and oscillate back and forth over the surface of the polishing pad to improve polishing effectiveness.

Following the CMP process, the semiconductor wafer is typically subjected to a post CMP cleaning process, both processes generally automated in one cleaning apparatus. The post CMP cleaning process generally includes a cleaning solution used in conjunction with a brushing process, a dipping process or megasonic energy.

One problem with the CMP processes of the prior art involving copper interconnect lines such as vias and trench lines has been the occurrence of the formation of recesses within the metal interconnect lines. The problem has been found to be particularly apparent in the case of trench lines with relatively longer linear interconnect dimensions. The erosion of copper filled metal interconnect lines, for example trench lines, to form recesses has been observed to occur during the post CMP cleaning stage where the semiconductor wafer is subjected to, for example, brushing or scrubbing while being simultaneously contacted with an acidic cleaning solution. The erosion of the copper in the metal interconnect lines to form recesses leads to semiconductor device failure by resulting in, for example, reduced electromigration (EM) lifetimes or electrical opens thereby leading to semiconductor device failure.

During the CMP process, the top surface of the copper layer may be oxidized and forms copper oxide, for example copper oxide (Cu₂O or CuO) or copper hydroxide (Cu(OH)₂). During the post-CMP cleaning process, typically involving rotary brush cleaning, in basic or neutral pH cleaning environments the copper oxide or copper hydroxide does not dissolve and may be transferred to the brushes, thus loading the brushes. The contaminated (or loaded) brushes may then transfer the copper oxide or copper hydroxide contaminants to subsequently processed substrates during cleaning. This problem has been addressed by using slightly acidic cleaning solutions aid in the dissolution of the copper oxide or copper hydroxide particles. Unfortunately it has been found that the slightly acidic solution may accelerate the erosion of copper filled metal interconnect lines, although the mechanism for such erosion has not been entirely clear.

Turning to FIG. 1A, is a cross sectional graphical representation of a portion of a multilayer semiconductor wafer 10 showing copper filled vias e.g., 12 formed in dielectric layer 11, interconnecting trench lines e.g., 14, the trench lines horizontally interconnecting different areas of the semiconductor device within the dielectric layer (ILD) e.g., 16. Following the filling of the trench lines with copper in each of the dielectric layers, e.g., 16, the semiconductor wafer 10 is subjected to a CMP planarization process to prepare the semiconductor wafer for further processing to form e.g., via 18 in dielectric layer 20, followed by another CMP processing step to form trench line e.g., 22 in dielectric layer 24.

It has been found as shown in FIG. 1B that the cleaning procedure using acidic cleaning solutions, including slightly acidic, for example with a pH of about 3.0 to about 5.0 can resulting chemical attack and corresponding erosion (corrosion) of copper (including an oxide layer thereover) to form recesses e.g., 26 primarily in the upper surfaces of the trench lines where the copper is exposed to the acidic cleaning solution during each post CMP cleaning stage.

Therefore, there is a need in the semiconductor art to develop a post CMP cleaning process whereby chemical attack of copper filled metal interconnect lines is minimized thereby avoiding the formation of recesses leading to a reduced electromigration lifetime and semiconductor device failure.

It is therefore an object of the invention to provide a post CMP cleaning process whereby chemical attack of copper filled metal interconnect lines is minimized thereby avoiding the formation of recesses leading to a reduced electromigration lifetime and semiconductor device failure while overcoming other shortcomings and deficiencies in the prior art.

### SUMMARY OF THE INVENTION

To achieve the foregoing and other objects, and in accordance with the purposes of the present invention, as embodied and broadly described herein, the present invention provides a method for preventing a photo-induced chemical attack on a copper containing dielectric material.

In a first embodiment according to the present invention, the method includes providing a copper or copper oxide containing dielectric material having an exposed copper containing surface; providing an acidic cleaning solution for contacting the exposed copper containing surface; and, shielding the exposed copper containing surface to substantially block incident light from impacting the exposed copper containing surface while contacting the exposed copper containing surface with the cleaning solution.

In related embodiments, the copper containing substrate includes a semiconductor substrate having copper filled metal interconnects. Further, the incident light source has a wavelength of between about 300 nanometers and about 800 nanometers.

In other related embodiments, the acidic cleaning solution has a pH of between about 3.0 to about 4.5

In another embodiment, the step of shielding is performed during a post-CMP cleaning process. Further, the post-CMP cleaning process includes contacting the substrate with the cleaning solution according to at least one of a dipping process, a brushing process, and megasonic cleaning process. Further yet, the post CMP cleaning process is automated for processing a substrate through a plurality of cleaning stations.

In another embodiment, the step of shielding includes placing a light blocking means between the incident light and the copper containing substrate to include the cleaning solution contacting the copper containing substrate.

In another related embodiment, the step of shielding includes placing a light blocking means to at least partially surround each of the plurality of cleaning stations.

These and other embodiments, aspects and features of the invention will be better understood from a detailed description of the preferred embodiments of the invention which are further described below in conjunction with the accompanying Figures.

### BRIEF DESCRIPTION OF THE DRAWINGS

FIGS. 1A and 1B are representative cross section side view representations of a portion of a multilayer semiconductor device showing the effects of erosion according to the prior art.

FIG. 2 is a schematic representation one embodiment of the operational implementation of the method according to the present invention in operation.

FIGS. 3A and 3B are representative operational embodiments of light shielded cleaning procedures according to the present invention.

FIG. 4 is oxidation potentials of a copper electrode exposed to incident light in a cleaning solution according to the present invention.

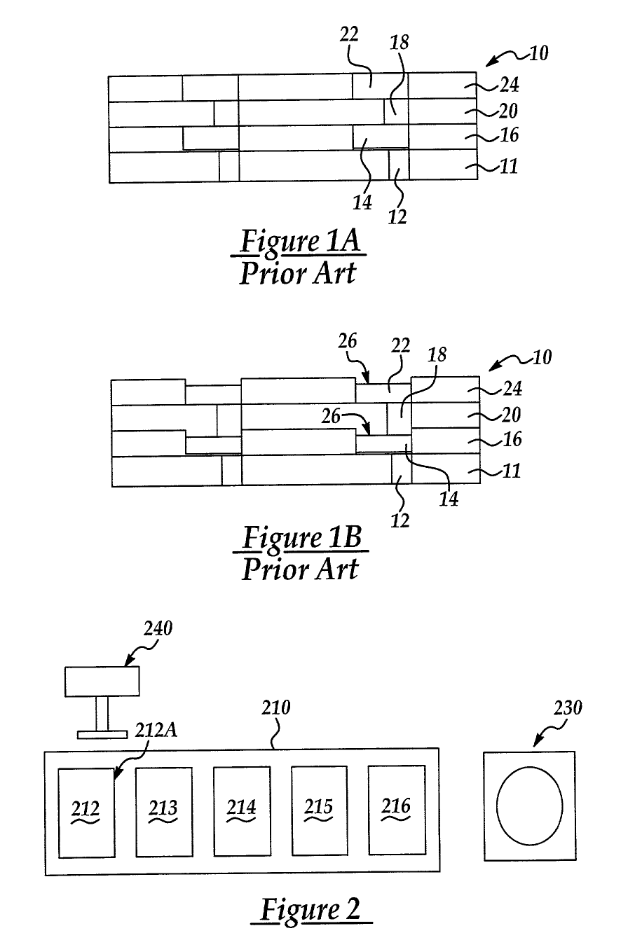

### DETAILED DESCRIPTION OF THE PREFERRED EMBODIMENTS

Although the method of the present invention is explained by reference to particular post CMP cleaning apparatus it will be appreciated that any type of semiconductor cleaning apparatus and cleaning method may advantageously modified according to the present invention where the cleaning method or apparatus involves cleaning a copper containing substrate, for example a copper containing dielectric layer included in a semiconductor wafer, with a cleaning solution under acidic conditions where the copper containing substrate is subjected to incident light while in contact with the cleaning solution. By incident light is meant light with a wavelength having a wavelength of between about 300 nanometers and about 800 nanometers.

It has been unexpectedly found that copper erosion to form recesses in copper filled interconnect lines, for example, trench lines in a multi-layer semiconductor device is avoided when a post CMP cleaning procedure is carried out in an acidic cleaning solution while being substantially shielded from visible and ultra-violet light impacting the copper filled interconnect lines. The copper filled interconnect lines may additionally including copper oxide (CuO, Cu₂O) containing surfaces. It has been found that the erosion is especially pronounced when the cleaning solution has a pH of between about 3.0 and about 5.0.

For example, FIG. 4 shows cyclic voltometry data of a copper electrode in an acidic cleaning solution with a pH of about 4. The vertical axis is the log of current density while the horizontal axis is oxidation potential in Volts versus a reference Ag/AgCl electrode. Other relevant operating parameters include a spin rate for the electrode of about 2000 rpm and a scan rate of about 0.01 V/sec. Line A represents the electrochemical oxidation potential under normal conditions including having the electrode subject to incident light (having a wavelength of about 350 to about 700 nm) while contacting the cleaning solution. Line B represents the electrochemical oxidation potential under substantially light shielded conditions (dark conditions), e.g., incident light upon the electrode while in contact with the cleaning solution is substantially blocked from impacting the electrode. The shift of the minimum (e.g., C1) in current density to more positive electrochemical oxidation potential under dark conditions (e.g., C2) is analogous to what is believed to be an increase of the activation energy for formation of copper oxide (e.g., CuO or Cu₂O) or copper hydroxide (e.g., Cu(OH)₂) thereby slowing the rate of erosion of the copper metal interconnect lines.

Although the details of the photo-induced electrochemical reaction are unknown, it is believed that a photo-assisted electrolysis process lowers an activation of energy for copper to form a positively charged ion, e.g., Cu⁺ which is then solvated into solution when electron donors in the solution are present, for example, including water or hydroxyl ions. The electrolysis reaction may be related to activation of a material included in the substrate surface, for example copper or copper oxide (CuO, Cu₂O) together with electrochemical half-reactions in an associated electrolyte solution. Copper oxide is typically present over copper surface due to ambient oxidation processes. The term “copper” as used herein includes copper, and alloys thereof to include copper oxide, e.g., (CuO, Cu2O).

According to the present invention, a post-CMP cleaning process is carried out where the copper containing substrate is at least partially shielded from incident light including light in the visible or ultra-violet light range while contacting the cleaning solution. In one embodiment of the invention, the cleaning solution is weakly acidic, having a pH between about 3.0 and about 4.5.

In another embodiment of the invention, the post-CMP cleaning process including the semiconductor wafer and the cleaning solution is at least partially shielded by a light blocking means from incident visible or ultraviolet light, for example, having a wavelength between about 300 nanometers and about 800 nanometers. The light blocking means may include, for example, a black box disposed to at least partially surround a cleaning process where the copper containing substrate (including a semiconductor wafer) is being contacted with a cleaning solution to substantially block incident light from impacting the cleaning solution while contacting the copper containing substrate.

In a typical post-CMP cleaning apparatus, for example, a brush cleaner is used in a brush cleaning process to clean a semiconductor wafer following a CMP process. The brush cleaner cleans the wafer using a combination of rinsing, megasonic rinsing, and brush cleaning.

In exemplary operation, the process wafers are loaded into a wet environment, usually de-ionized water, and then transported through a series of cleaning chambers for the brush cleaning cycle. The brush cleaning cycle involves rotating the process wafer at high speed, for example, about 1500 rpm, while a jet of deionized water is sprayed on the process wafer and the process wafer surface is brushed with a foam brush to dislodge any loose debris.

During the brush cleaning cycle, the brush is first placed over the center of the wafer. The brush contacts the backside of the wafer, presses down on the wafer, and moves at a constant height and pressure to the periphery of the wafer in one stroke. The brush then retracts from the wafer and the whole cycle is repeated. Additional chambers brush the top side of the wafer. After the brushing cycles, the wafer is deposited in the spin/rinse/dry chamber and unloaded dry.

In an exemplary embodiment, as shown in FIG. 2, a conventional wafer cleaning apparatus includes an external housing 210, a plurality of cleaning stations e.g., 212 to 216, a drying station 230, and a robot transfer arm 240. Cleaning station 212, for example corresponds to a megasonic cleaning station, followed by cleaning stations 213 to 216 corresponding, for example, to first brushing, first rinsing, second brushing and second rinsing stations, respectively. Each of the cleaning stations 212 to 216 contains either a cleaning solution or rinsing solution being supplied by, for example, a nozzle means during brushing or scrubbing operation. Each cleaning station where an acidic cleaning solution contacts the semiconductor wafer is equipped with an individual light blocking shields, e.g., 212A, automated for example to be positioned to substantially block incident light from impacting the copper containing semiconductor surface while in contact with the cleaning solution. For example, automated means for positioning the light blocking shields to shield the semiconductor surface for example, upon applying the cleaning solution to the semiconductor wafer through a spraying means or upon dipping the semiconductor wafer in order to prevent the simultaneous exposure to light and to the acidic cleaning solution. The drying station 230 dries the cleaned wafers, for example by a spin drying process. The robot transfer arm 240 loads the wafers in the cleaning station 212, transports the wafers by robot arm 240 progressively through the cleaning stations 212 to 216 and finally to drying station 230. Generally multiple wafers may be transported through this process at a single time within a wafer cassette. The wafer cassette may additionally include a light blocking means (not shown) if the acidic cleaning solution remains on the semiconductor wafer surface.

In case of the above exemplary cleaning apparatus, the use of different cleaning solutions results in an increase in the number of washing and rinsing stations required. It also increases the number of transfers within the apparatus for each wafer. Optionally, the wafers may be transported individually using a robot transfer arm. This allows the cleaning of large diameter semiconductor wafers and improves the productivity of the manufacturing process. This cleaning technique requires accurate positioning of wafers in the individual process vessels requiring, for example, a wafer position detection means to detect whether a wafer is accurately positioned in the respective cleaning station and controlling a wafer transfer robot in response to the detected signal. For example, a light emitting and detecting means may be used as the wafer position detection means requiring incident light to impact a wafer surface for a short period of time.

Incident light as used herein is defined to exclude temporary incident light associated with a wafer detecting means. As discussed, some cleaning apparatus have light emitting and detecting means to determine if a wafer is held in a particular position in a cleaning apparatus.

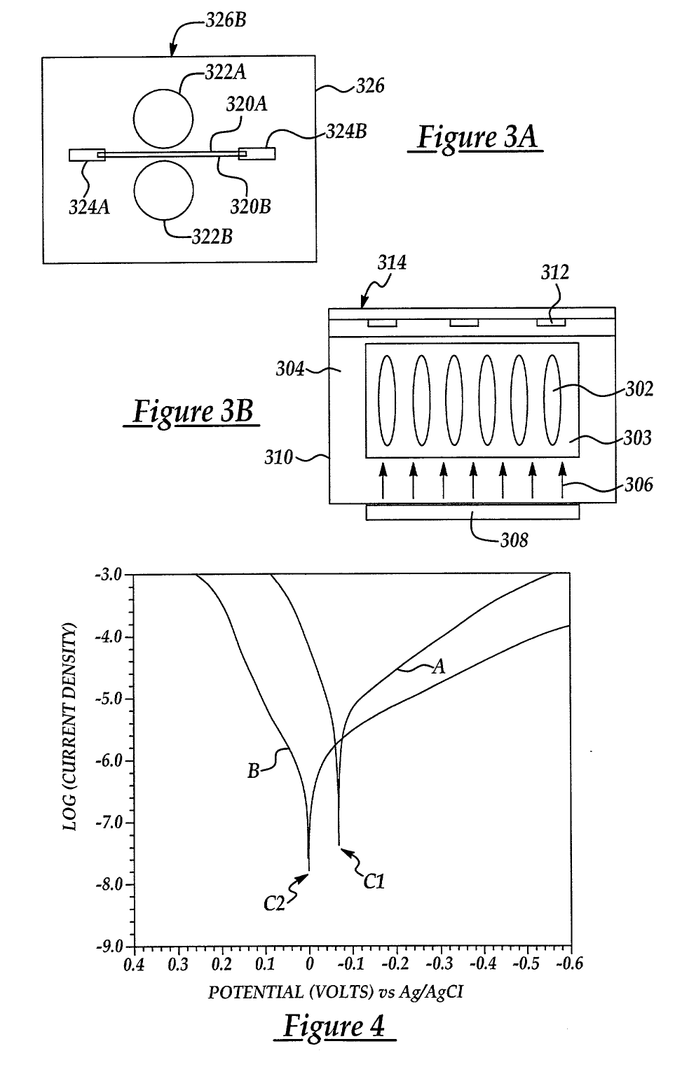

For example, the mechanical brushing action on the semiconductor surface is preferably supplied by a rotary type brush either immersed in the cleaning solution or equipped with commercially available brushes that include a spraying source for the cleaning solution. As shown in FIG. 3A both semiconductor wafer surfaces e.g., 320A and 320B may be contacted with one or more rotary brushes e.g. , 322A and 322B while the semiconductor wafer surfaces are, for example, mounted on rollers 324A and 324B with the wafer oriented for example, horizontally, such that both the rotary brush and the semiconductor wafer rotate to allow for the entire wafer surface to be brushed. The wafer may either be immersed in the cleaning solution or have the cleaning solution supplied by cleaning solution feeds located near the wafer surface or included as part of the brushing fixture. The wafer may further be optionally oriented in other directions such as vertically with rotary brushes contacting both surfaces of the wafer while the wafer is rotated. According to one embodiment of the present invention, a light blocking housing e.g., 326 including an automated light blocking lid 326B arranged to close upon immersing the semiconductor wafer in cleaning solution or upon supplying the cleaning solution to the semiconductor surface. It will be further appreciated that type of brushing action, whether vertically directed or horizontally directed is unimportant to the practice of the invention as long as the semiconductor wafer while in contact with the cleaning solution is substantially shielded from incident light having a wavelength of between about 300 nanometers and about 800 nanometers.

Preferably, a conventional megasonic cleaning process is used as the sonic cleaning process which includes a transducer producing sonic energy at a frequency of about 850 to 900 kHz. The sonic energy is preferably directed parallel to the semiconductor wafer surfaces. In exemplary operation, referring to FIG. 3B, semiconductor wafer surfaces e.g., 302 held in cassette 303, are immersed in cleaning solution 304 such that semiconductor wafer surfaces e.g., 302 are oriented parallel to the direction of travel of the sonic waves e.g., 306 produced by the transducer 308, typically mounted against the outside of a cleaning solution container 310, container 310 shielding the semiconductor wafer surfaces e.g., 302 and the cleaning solution 304 from incident visible or ultraviolet light irradiation, for example, having a wavelength of between about 300 nanometers and about 800 nanometers. Fresh cleaning solution may be added at the top portion of container 310 through solution supply feeds e.g., 312. Both automated megasonic cleaning devices and automated mechanical brushing devices are commercially available, the particular type being unimportant to the present invention as long as the semiconductor wafer while in contact with the cleaning solution is substantially shielded from incident visible or ultraviolet radiation having a wavelength between about 300 nanometers and about 800 nanometers. It will be appreciated, that any conventional mechanical brushing device and megasonic cleaning device equipped with a light blocking means for substantially blocking incident light from impacting the semiconductor wafer surface while being contacted with a cleaning solution, for example an automated closing lid (e.g., 314) upon immersion of the semiconductor wafer(s) in the cleaning solution may be utilized according to the present invention.

The preferred embodiments, aspects, and features of the invention having been described, it will be apparent to those skilled in the art that numerous variations, modifications, and substitutions may be made without departing from the spirit of the invention as disclosed and further claimed below.

What is claimed is:

1. A method for preventing a photo-induced chemical attack on a copper containing dielectric material comprising the steps of:
providing a copper or copper oxide containing dielectric material having an exposed copper containing surface;
providing an acidic cleaning solution for contacting the exposed copper containing surface; and
shielding the exposed copper containing surface to substantially block incident light from impacting the exposed copper containing surface while contacting the exposed copper containing surface with the cleaning solution.

2. The method of claim 1, wherein the copper containing substrate includes a semiconductor substrate having copper filled metal interconnects.

3. The method of claim 1, wherein the incident light source has a wavelength of between about 300 nanometers and about 800 nanometers.

4. The method of claim 1, wherein the acidic cleaning solution has a pH of between about 3.0 to about 4.5.

5. The method of claim 2, wherein the step of shielding is performed during a post-CMP cleaning process.

6. The method of claim 5, wherein the post-CMP cleaning process includes contacting the substrate with the cleaning solution according to at least one of a dipping process, a brushing process, and megasonic cleaning process.

7. The method of claim 6, wherein the post CMP cleaning process is automated for processing a substrate through a plurality of cleaning stations.

8. The method of claim 1, wherein the step of shielding includes placing a light blocking means between the incident light and the copper containing substrate to include the cleaning solution contacting the copper containing substrate.

9. The method of claim 7 wherein the step of shielding includes placing a light blocking means to at least partially surround each of the plurality of cleaning stations.

10. A method for preventing photo-induced chemical attack of a cleaning solution on a copper containing dielectric layer in a semiconductor wafer comprising the steps of:
providing a copper containing semiconductor wafer having an exposed surface including a copper containing dielectric layer;
providing a cleaning solution for contacting the copper containing dielectric layer; and
shielding the cleaning solution and the copper containing dielectric layer to substantially block incident light while contacting the copper containing dielectric layer with the cleaning solution.

11. The method of claim 10, wherein the copper containing dielectric layer includes copper filled metal interconnects.

12. The method of claim 10, wherein the incident light has a wavelength of between about 300 nanometers and about 800 nanometers.

13. The method of claim 10, wherein the cleaning solution is acidic.

14. The method of claim 13, wherein the cleaning solution has a pH of between about 3.0 to about 4.5.

15. The method of claim 10, wherein the step of shielding is performed during a cleaning process following a chemical mechanical polishing (CMP) process.

16. The method of claim 15, wherein the cleaning process includes contacting the substrate with the cleaning solution according to at least one of a dipping process, a brushing process, and a megasonic cleaning process.

17. The method of claim 16, wherein the cleaning process includes an automated process for processing the substrate at a plurality of cleaning stations.

18. The method of claim 16, wherein the step of shielding includes placing a light blocking means between the incident light and the cleaning process.

19. The method of claim 18, wherein placing a light blocking means includes placing a light blocking means to at least partially surround the cleaning process.

20. The method of claim 17 wherein the step of shielding includes placing a light blocking means to at least partially surround each of the plurality of cleaning stations.
